(19) United States
(12) Patent Application Publication
(10) Pub. No.: US 2012/0186533 A1
(43) Pub. Date: Jul. 26, 2012

(54) Foldable Pet Animal Carrying Bag

(76) Inventor: Kongzhi LU, Xiamen (CN)

(21) Appl. No.: 13/073,566

(22) Filed: Mar. 28, 2011

(30) Foreign Application Priority Data
Jan. 25, 2011 (CN) 201120023896.7

(51) Int. Cl. A01K 1/00

(52) U.S. Cl. 119/497

(57) ABSTRACT

Present invention disclosed and claimed a double-zipper based foldable pet carrying bag with easy fold-down and flattened features, teaching the construction of a simple yet cost-effective animal carrying bag that provides an easy-to-use and easy-to-store-away bag, so that it is comfortable for both people carrying the pet animals and the animals being carried around.

### CLAIM FOR FOREIGN PRIORITY

The present invention claims the earlier filing date of a foreign filing in China, dated Jan. 25, 2011, having application number 201120023896.7.

### FIELD AND BACKGROUND OF PRESENT INVENTION

Keeping pets and other small animals around people's living environment has become a way of life. People enjoy the company of their pet animals; such companionship is known to be conducive to people's health, both to the physical and psychological aspects.

However, pet owners do not always stay at home. Traveling has become a natural part of life. As such, modern living with pet animal companionship in traveling also necessitates the proper means for carrying pets. Such means need to be cost-effective and reasonably comfortable to the pets.

Although some variations of animal carrying bags are available, none of them provides the utility of easy to use and convenient to fully collapse and store away feature.

Present invention provides a simple yet cost-effective carry device that provides an easy-to-use and easy-to-store-away bag for carrying animals around, so that it is comfortable for both people carrying the pets and the pets being carried around.

### OBJECT AND SUMMARY OF THE PRESENT INVENTION

Present invention teaches a foldable pet carrying bag that has a generally rectangular bottom plate, with a side wall vertically surrounding the four sides.

The side wall is further divided into a front vertical cover, a rear vertical cover, a left vertical cover, and right vertical cover. All of them are connected to the bottom plate on the floor end, with a two-zipperline construction providing the zip-down structure.

When the bag of present invention is fully expanded in a ready-to-use state, the two zipper pulls of zippers will meet at the top of right vertical cover, on the front side, and the other two zipper pulls of zippers will meet at the top of right vertical cover, on the rear side.

When the zippers are unzipped to the bottom plate, the front and rear covers can be folded towards the bottom plate and form a flattened pile; a Velcro is then used to keep the flattened shape, for easy store-away.

Some pane of mesh type material is provided to the walls (the covers) of the bag, so that the pets being carried have good ventilation.

### BRIEF DESCRIPTION OF THE DRAWINGS

FIG. 1 is the perspective view of the carrying bag of present invention, with the front cover shown facing towards the left side of the page.

FIG. 2 is the perspective view of the carrying bag, with side pocket (of the left cover) shown, and the rear cover shown with a pane of mesh material.

FIG. 3 shows the right vertical cover being zipped down along the two parallel zipper lines, forming an exit/entrance for the animal to be carried.

FIG. 4 shows all the zippers are pulled down, readying the bag for collapsing and storing away.

FIG. 5 shows the bag of present invention in collapsed state and a Velcro on top of rear vertical cover helps to keep the flattened shape, easy for storage and transport.

### DETAILED DESCRIPTION OF THE PREFERRED EMBODIMENT

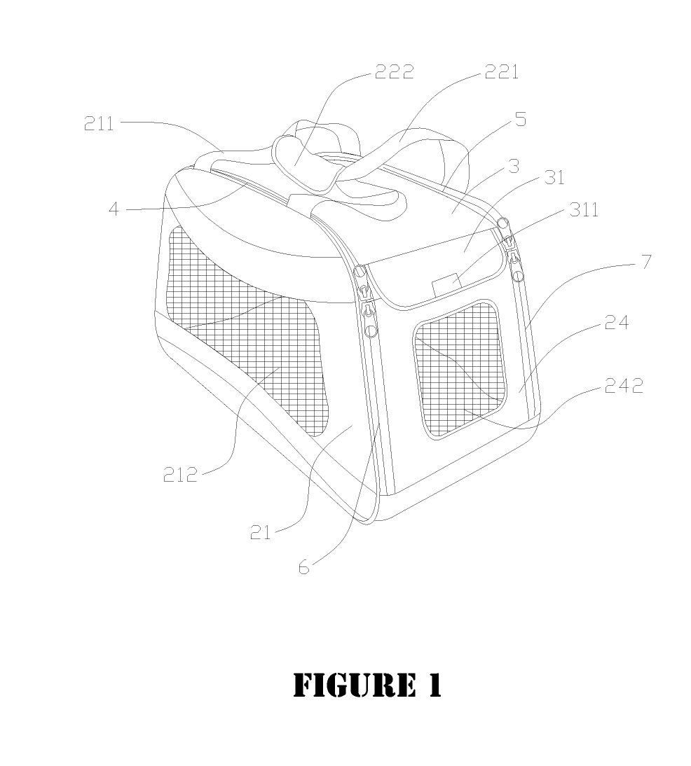

Referring to FIGS. 1-5.

The foldable pet carrying bag of present application has a generally rectangular bottom plate 1, which is connected to side wall 2, which in turn consists of a front vertical cover 21, rear vertical cover 22, left vertical cover 23 and right vertical cover 24 on the four sides. Left vertical cover 23 is foldably connected to a top cover 3.

The material for the outside surface of the covers and the bottom plate will be some suitable fabric that will work with Velcro. Such materials are available on the market and do not form the basis of the disclosure or claimed subject matter in and of themselves.

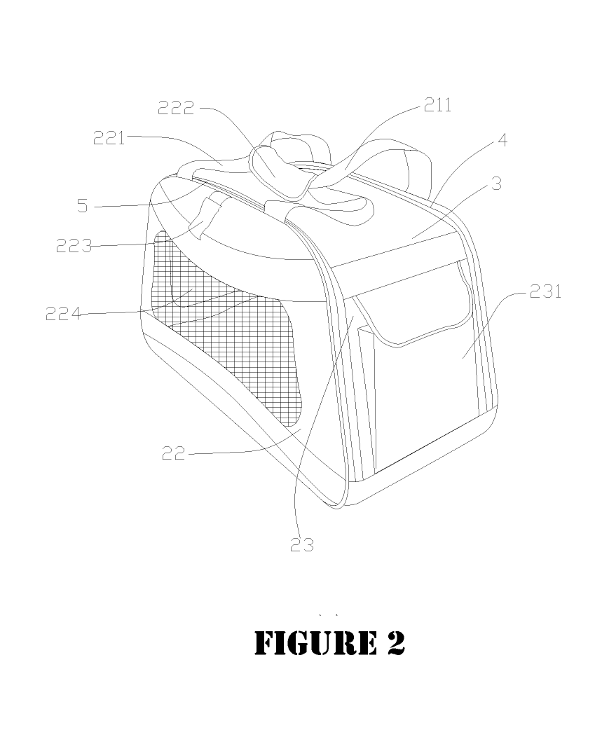

FIG. 2 shows the connection of left vertical cover 23 to top cover 3.

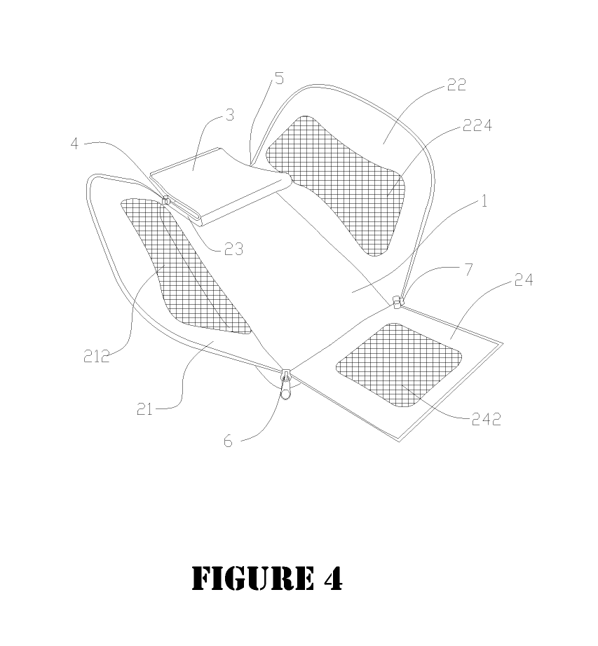

FIG. 4 shows the top cover 3 is foldably connected to the left vertical cover 23, when the bag is in a about-to-collapse state.

Although the 4 covers (21/22/23/24) making up side wall 2 are named “vertical”, that name is not limited to the strict meaning of true “vertical”, but simply denoting their general orientation when the bag is fully expanded for use and for descriptive purpose.

Along with top cover 3, left vertical cover 23 can be joined together to front vertical cover 21 by a zipper 4, on the front side of the carrying bag. Left vertical cover 23 can be joined together to rear vertical cover 22 by a zipper 5, on the rear side.

Zipper 5 and zipper 7 move on the same zipper line along the edge of rear vertical cover 22; zipper 4 and zipper 6 move on the same zipper line along the edge of front vertical cover 21.

When the bag of present invention is fully expanded in a ready-to-use state, the two zipper pulls of zippers 4 and 6 will meet at the top of right vertical cover 24, on the front side, and the two zipper pulls of zippers 5 and 7 will meet at the top of right vertical cover 24, on the rear side. The distal tip of top cover 3 will be adjacent to the top of right vertical cover 24.

FIG. 1 shows the bag of present invention in fully expanded and ready-to-use state.

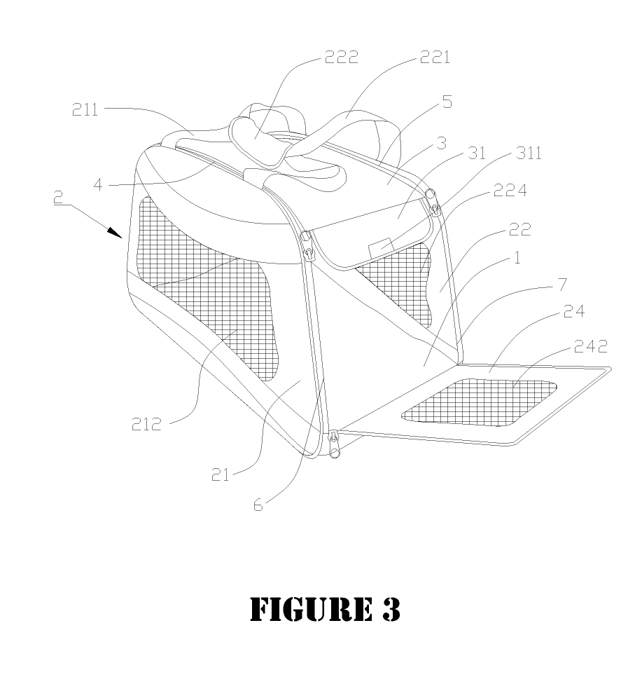

When zipper 6 and zipper 7 are zipped down along the two sides of right vertical cover 24, an opening is formed for exit/entry of pets, as shown in FIG. 3.

The top cover 3 has a blocking piece 31 at the end portion near the right vertical cover 24. A Velcro 311 is located at the very tip of blocking piece 31, for easy attaching/detaching to right vertical cover 24.

A first holding strap 211 is located on the top edge of front vertical cover 21; a second holding strap 221 is located on the top edge of rear vertical cover 22.

A Velcro 222 located in the mid-section second holding strap 22 serves to maintain a combined hold of the two holding straps 211 and 221.

A Velcro 223 is located on the top portion of rear vertical cover 22, so that when the carrying bag of present invention is unfolded and collapsed, the shape of a flattened pile can be maintained by using said Velcro 223 to keep the folded down front vertical cover 21 and rear vertical cover 22 in place.

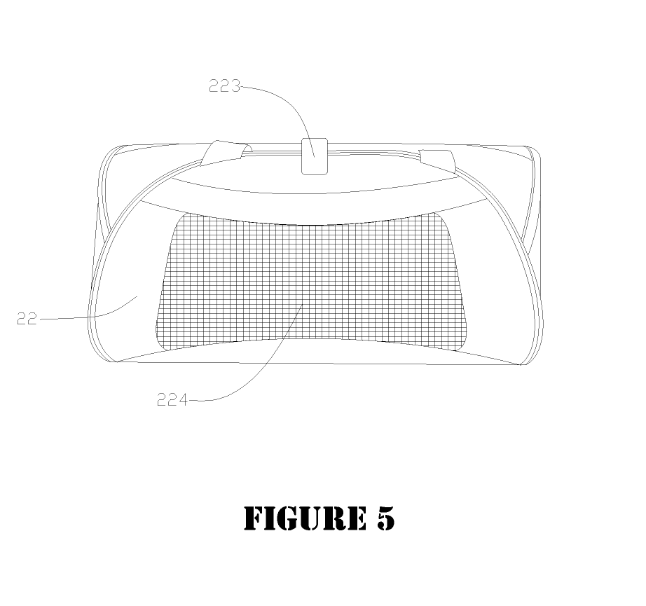

See FIG. 5, showing the bag in flattened state.

A pane of mesh 212 is provided on front vertical cover 21. A similar mesh 224 is provided on rear vertical cover 22. A pane of side mesh 242 is provided on right vertical cover 24.

A side pocket 231 is provided on left vertical cover 23, for purpose of storing food or accessory items for the pet being carried, as shown in FIG. 2.

When using the carrying bag of present invention, the bag is in a fully-erect position when zipper 6 will be touching zipper 4 (on the same zipper line in the front) and zipper 7 will be touching zipper 5 (on the same zipper line in the back). Zipper 6 and zipper 7 can be zipped down, and right vertical cover 24 can then open down to form an entry for pet to go in or out of the bag.

When zipper 4 and zipper 5 are pulled all the way back down to the bottom plate 1, top cover 3, left vertical cover 23 and right vertical cover 24 can then be folded down towards the top surface of the bottom plate 1; front vertical cover 21 and rear vertical cover 22 are also folded down towards the bottom plate 1, using Velcro 223 to secured the folded down bag and keep the flattened shape, easy for storage or transportation, as shown in FIG. 5.

What is claimed is:

1. A foldable pet carrying bag, comprising:
A generally rectangular bottom plate, with surround side wall connecting on the four sides, forming a front vertical cover, rear vertical cover, left vertical cover and right vertical cover;
A top cover connected to said left vertical cover;
Two parallel zipper lines located at front and back of the bag, wherein two front zippers travel on the same front zipper line and two rear zippers travel on the same rear zipper line and that when the bag is fully expanded, the four zipper pulls will meet at the point where the distal tip of top cover is adjacent to the top of right vertical cover; and,
A Velcro located on the top portion of rear vertical cover, serving to keep the flattened shape of a collapsed bag when all the zippers are pulled open and the four vertical covers are folded down to the bottom plate.

2. The pet carrying bag of claim 1, wherein a first holding strap is located on the top edge of the front vertical cover and a second folding strap is located on the top edge of the rear vertical cover, a Velcro in the mid-section of second holding strap serves to maintain a combination hold of the two holding straps.

3. The pet carrying bag of claim 2, wherein a blocking piece is connected to the end tip of top cover and further has a Velcro piece located at the very tip of said blocking piece, for easily attaching to the top portion of right vertical cover.

4. The pet carrying bag of claim 3, wherein a pane of mesh material is provided on front vertical cover.

5. The pet carrying bag of claim 3, wherein a pane of mesh material is provided on rear vertical cover.

6. The pet carrying bag of claim 3, wherein a pane of mesh material is provided on right vertical cover.

7. The pet carrying bag of claim 3, wherein a pocket is provided on left vertical cover, for purpose of storing food or other accessory items.
